(19) United States
(12) Patent Application Publication
(10) Pub. No.: US 2018/0184451 A1
(43) Pub. Date: Jun. 28, 2018

(54) CONTENTION BASED SPATIAL SHARING IN WIRELESS COMMUNICATIONS

(71) Applicant: Intel Corporation, Santa Clara, CA (US)

(72) Inventors: Rath Vannithamby, Portland, OR (US); Yi Zhang, Portland, OR (US); Mohammad Mamunur Rashid, Hillsboro, OR (US); Carlos Cordeiro, Portland, OR (US); Arvind Merwaday, Hillsboro, OR (US); Ou Yang, Santa Clara, CA (US)

(73) Assignee: Intel Corporation, Santa Clara, CA (US)

(21) Appl. No.: 15/392,115

(22) Filed: Dec. 28, 2016

(51) Int. Cl. H04W 74/08; H01Q 21/24

(52) U.S. Cl. CPC H04W 74/08; H01Q 21/24

(57) ABSTRACT

In wireless communication networks in which pairs of STAs establish direct point-to-point links with each other, RTS-CTS training may be used to make sure that they don't interfere with other such pairs that communicate simultaneously during contention based access periods (CBAP). In some embodiments, two different types of CBAP are described for this. The PCP/AP may separately designate each type of CBAP for those devices using RTS-CTS training and those not using such training. In other embodiments, specific formats and fields are presented for communications involving these features.

### BACKGROUND

In a wireless network containing a network controller (e.g., an AP) and multiple mobile devices (e.g., STAs), sometimes a pair of STAs will establish a direct communications link with each other (i.e., communication between those two STAs does not have to be routed through the AP). If these two STAs have the capability for directional communication, that link may also be a directional link. However, even though their link is directional, their communication with each other may still cause interference with other devices, either due to the position of those other devices or because of the side lobes of the directional transmissions. Steps may need to be taken to see if such communication interferes with communication by other directional pairs, to determine if spatial reuse can take place (i.e., each pair communicates over their respective directional links at the same time). Traditionally, such spatial reuse takes place during Service Periods (SP), in which STA communication is scheduled by the AP and therefore the AP can avoid potential interference situations. But there is an increasing need for such spatial reuse to take place during Contention Based Access Periods (CBAPs), which are periods for unscheduled first-come first-serve access to the medium. Currently known techniques for STA-pair spatial reuse during a CBAP incur additional overhead that contributes to reduced bandwidth during the affected transmission periods. Since the AP is not scheduling these communications, and the STAs are trying to randomly access the medium, this leave spatial reuse and its overhead burden essentially unmanaged, to the detriment of the network.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a block diagram of a wireless communication device 100, according to an embodiment of the invention.

FIG. 2 shows a block diagram of a network 200, according to an embodiment of the invention.

FIG. 3 shows a timing diagram of antenna training sequence that uses training fields appended to RTS and CTS transmissions.

FIG. 4 shows a timing diagram of specific time periods during a Beacon Interval, according to an embodiment of the invention.

FIG. 5 shows a format for an Allocation field in a communications frame, according to an embodiment of the invention.

FIG. 6 shows a format for a subfield in the Allocation field of FIG. 5, according to an embodiment of the invention.

FIG. 7 shows a flow diagram of a method, according to an embodiment of the invention.

### DETAILED DESCRIPTION

### Terms and Definitions

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. Those instructions may then be read and executed to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The term “wireless” may be used to reference the communication of data by using modulated electromagnetic radiation propagated through a non-solid medium. A wireless device may comprise at least one antenna, at least one radio, at least one memory, and at least one processor, where the radio(s) transmits signals through the antenna that represent data and receives signals through the antenna that represent data, while the processor(s) may process the data to be transmitted and the data that has been received. The processor(s) may also process other data which is neither transmitted nor received. The memory may contain instructions and/or data.

As used within this document, a network controller may schedule and control, at least partially, wireless communications by other devices in the network. A network controller may be described by the terms “access point” (AP), PBSS Control Point (PCP), PCP/AP, base station (BS), or any other term that may arise to describe the functionality of an AP.

As used within this document, the term “station” (STA) is intended to cover those devices whose wireless communications are at least partially scheduled and controlled by the network controller. A STA may also be known as a mobile device (MD), mobile station (MS), subscriber station (SS), user equipment (UE), or any other term that may arise to describe the functionality of a STA. STAs may typically be capable of moving while communicating, but such movement is not required.

As used within this document, the term “communicate” is intended to include transmitting and/or receiving. Similarly, the term “communicate” may refer to the bidirectional exchange of data between two devices (both devices transmit and receive during the exchange).

Directional transmission—transmitting wireless signals in a manner that focuses most of the transmission energy in one direction, so that it is most likely to be received by other devices that are in that direction, and less likely to be received by devices in other directions.

Directional reception—receiving wireless signals in a manner such that incoming signals are received most clearly from a particular direction.

Spatial Reuse—directionally communicating in different directions (spatial channels) over the same frequency channel(s) at the same time. The directionality of the communications may be used to allow multiple communication links between different devices to operate simultaneously over the same frequencies, even though the different links might interfere with each other if the communications were omni-directional. Different content may be simultaneously communicated over the different spatial channels.

Spatial reuse pair—two wireless devices that communicate directionally with each other over a spatial channel. Other spatial reuse pairs may operate simultaneously in the same vicinity over the same frequency channels but different spatial channels.

Training sequence—a series of communications between two devices that permits them to tune their antenna arrays in a manner that establishes a spatial channel between them. Training sequence can also refer to tuning the antenna array in a manner that avoids interference with or by other devices that are in specific directions.

Spatial Reuse Training—a type of training sequence that tests whether communication over a previously-established directional link between two devices causes interference with simultaneous communication over another previously-established directional link between two other devices.

Service period (SP)—a period of time designated for scheduled communications within a network. Scheduled communication may occur within the SP when an AP assigns specific times for specific STAs to communicate.

Contention based access period (CBAP)—a period of time designated for contention-based communications within a network. With CBAP, each STA that wants to transmit must contend with the other STAs to obtain control of the wireless medium. This is typically done on a first-come first-serve basis, with various techniques used to resolve a tie when two devices attempt to access the medium at the same time.

In the following description, numerous specific details are set forth. However, it is understood that embodiments of the invention may be practiced without these specific details. In other instances, well-known structures and techniques have not been shown in detail in order not to obscure an understanding of this description.

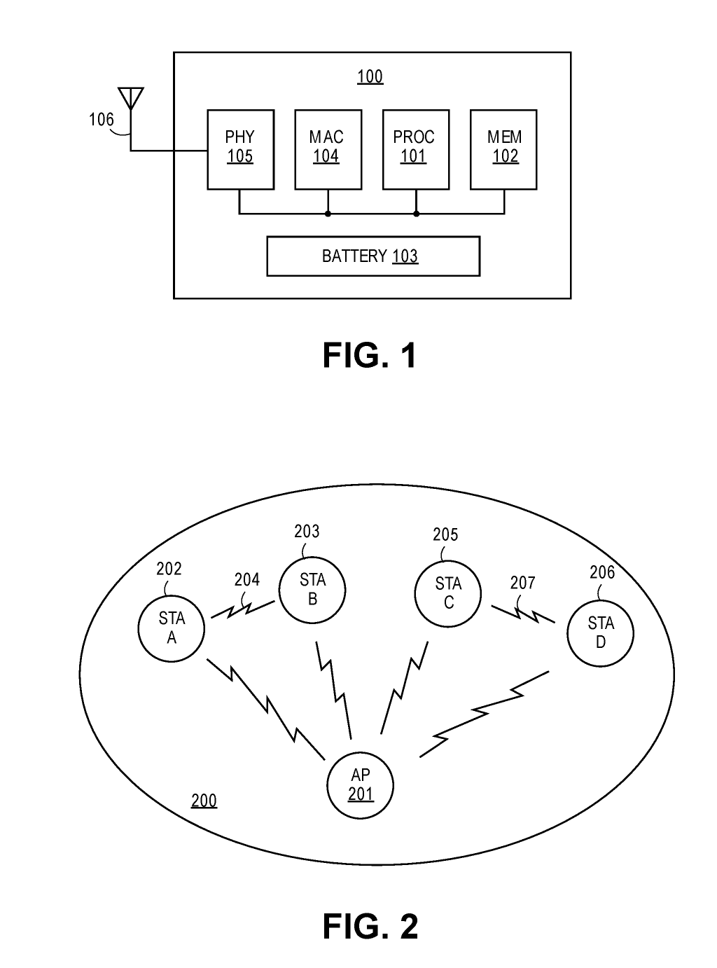

FIG. 1 shows a wireless communication device 100, according to an embodiment of the invention. Device 100 may include at least one processor 101, at least one memory 102, battery 103, medium access (MAC) module 104, physical (PHY) module 105, and at least one antenna array 106. Using an ‘array’ of antennas may permit the communications to be directional by adjusting the phase and/or amplitude of the signal to/from various antennas in the array. Device 100 may also contain a baseband processor, which may reside in MAC 104, PHY 105, or both. Among other uses, the at least one memory 102 may contain instructions which when executed cause performance of operations described in this document.

FIG. 2 shows a wireless communications network 200, according to an embodiment of the invention. Network 200 may comprise PCP/AP 201, STAs 202 (STA A), 203 (STA B), 205 (STA C), and 206 (STA D), each of which may contain some or all of the elements of device 100. Other STAs may also be in network 200, but are not shown for simplicity of description. As seen from FIG. 2, each of STAs A, B, C, and D may communicate wirelessly

with PCP/AP 201. Whether these PCP/AP-to-STA links are directional or non-directional is not considered relevant to the embodiments of the invention. However, communications link 204 may be a directional link between devices 202 and 203, while communications link 207 may be a directional link between devices 205 and 206. The method of establishing directional links 204 and 207 may have relevance to advantages of various embodiments of the invention.

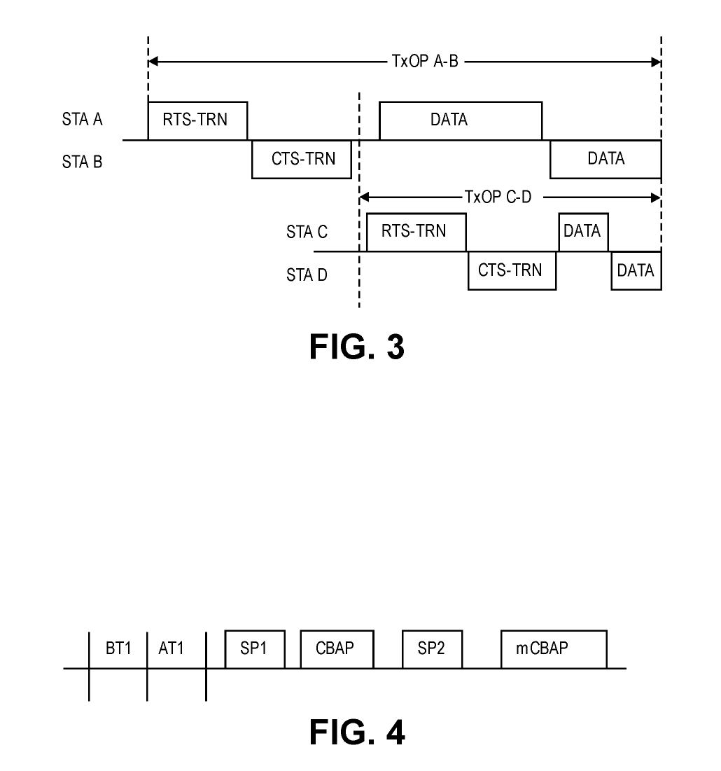

FIG. 3 shows a timing diagram of antenna training sequence that uses training fields appended to RTS and CTS transmissions. A standard RTS and CTS exchange may not include such training, while an RTS-TRN and CTS-TRN sequence should. (These labels are used for convenience; other labels may be used as well). Using STAs A and B as an example, multiple receiver training sequences may be appended to an RTS (RTS-TRN) transmitted by STA A and addressed to STA B, and the RTS may include an indication that such training sequences are appended. The receiving STA B may then try different antenna weight vectors (AWV) for each sequence to see which is the best match, and thereby be able to train its antenna array for directional receiving for a link with STA A. Under the assumption that AWV for both receiving and transmitting are related in a known manner for a given direction, the transmission AWV for STA B can also be derived.

STA B may then transmit a CTS-TRN to STA A, with the training sequences appended. In a manner similar to that just described, STA A may try different AWVs for the multiple training sequences to see which is the best match, and thereby be able to derive its own receive and transmit AWVs for a directional link with STA B. In this manner, STAs A and B may determine the respective AWVs for a directional link with each other.

As an advantage of the described RTS-TRN and CTS-TRN exchange, while trying different AWVs, a receiving device (e.g., in this case either STA C or STA D) may be able to detect interference from other devices (e.g., STA A or B) while using one or more of the AWVs being tested. And this information may be used to inform the receiving device that it should not try to transmit while the interfering device or spatial reuse pair is transmitting. Referring again to FIG. 3, if STA D detects interference from STA A or STA B, it knows it should not subsequently engage in a directional communication with STA C if STAs A and B are engaged in directional communication with each other. The same applies to STA C not engaging in directional communication with STA D if it detects such interference from STA A or STA B. In this manner, spatial pairs may determine if they can communicate at the same time as other spatial pairs in the same network without the likelihood of interfering with each other. In any event, the act of including training sequences in RTS-CTS should take longer because of the necessity of including multiple training sequences, thereby increasing the overhead burden. But such training has the advantage of detecting potential interference between pairs of STAs. This tradeoff may be important in deciding which spatial reuse pairs may communicate at the same time. If the interference information is passed to the PCP/AP, the PCP/AP can avoid the problem by scheduling the spatial reuse pairs at different times. However, allowing point-to-point (P2P) spatial reuse during a CBAP may sometimes be advantageous, if this tradeoff can be balanced.

FIG. 4 shows a timing diagram of specific time periods during a Beacon Interval, according to an embodiment of the invention. In FIG. 4, BTI represents a Beacon Time Interval during which one or more beacons may be transmitted by the PCP/AP. ATI represents an Announcement Time Interval request-response management access period between the PCP/AP and STAs. Both BTI and ATI are already known under those acronyms, and are not further discussed here.

In FIG. 4, the time periods labeled SPx may be Service Periods, or periods the PCP/AP has designated for scheduled communications between various devices, by designating when each device may take control of the communication medium. Such scheduling is intended to separate different communications in time so those communications won't interfere with each other. FIG. 4 shows two Service Periods, SP1 and SP2, indicating that two separate time periods have been set aside during the beacon interval for scheduled communication. However, one, two, or more than two Service Periods may be scheduled by the PCP/AP in this manner for any particular beacon interval. The scheduling that specifies when the SPs will occur may typically be indicated in a Beacon.

The time periods labeled CBAP and mCBAP may be Contention Based Access Periods, or periods the PCP/AP has designated for STAs to access the communication medium by contending for such access. Such contention is typically based on a first-come first-served approach, with various techniques used as a tie-breaker when two devices try to acquire the medium at the same time.

FIG. 4 shows two CBAP periods, which have been labeled as mCBAP (e.g., a first type of CBAP that is designated for STAs that meet certain criteria), CBAP (e.g., a second type of CBAP designated for standard use), although other labels could also be used. In one embodiment, STAs that are not intending to use training in their RTS-CTS exchange may access the medium during the CBAP, while STAs that are intending to use training in their RTS-CTS exchange may access the medium during the mCBAP.

One possible advantage of having separate CBAPs for spatial reuse and non-spatial reuse is to allow those STAs that use standard RTS and CTS to avoid having to wait for channel access while the longer RTS-TRN and CTS-TRN frames take place. However, based on the relative times occupied by spatial reuse pairs that use training and spatial reuse pairs that do not, this might create a saturated mCBAP (i.e., an mCBAP that does not have sufficient time to handle the demand) and a CBAP with idle time. This imbalance may reduce overall throughput in the network. Accordingly, the PCP/AP may adjust the relative periods of time it allocates for CBAP and mCBAP based on the relative demand for the two types of CBAPs. In one embodiment, the STAs may inform the PCP/AP of their history of use of RTS-TRN and CTS-TRN. In another, the STAs may inform the PCP/AP of their intended future use of RTS-TRN and CTS-TRN. The PCP/AP may then make the appropriate adjustments to the relative durations of CBAP and mCBAP. The STAs may provide this information to the PCP/AP in response to a request by the PCP/AP, or provide the information in a pre-determined manner without such request.

Since the length of the spatial reuse communications may be a factor (the inclusion of training takes longer), the PCP/AP may also send a packet threshold size limitation to the STAs: if their packet size (including any training) is below the threshold they may use the CBAP, while if it is above the threshold they may use the mCBAP. This is in keeping with the goal of keeping longer-duration communications separate from shorter-duration communications so as to more fairly allocate contention based access to the medium.

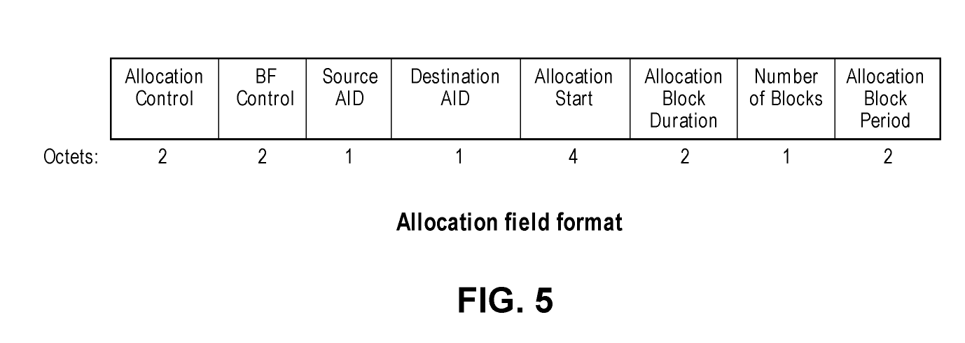

FIG. 5 shows a format for a field in a communications frame, according to an embodiment of the invention. The illustrated Allocation Field may be part of an Extended Schedule element in a Beacon or Announcement frame. Whereas the Source address identification (AID) and Destination AID subfields have previously been used to indicate the broadcast Source and Destination AIDs for CBAP usage, some embodiments of the invention have redefined these to be the PCP/AP Source and Destination AIDs for CBAP usage.

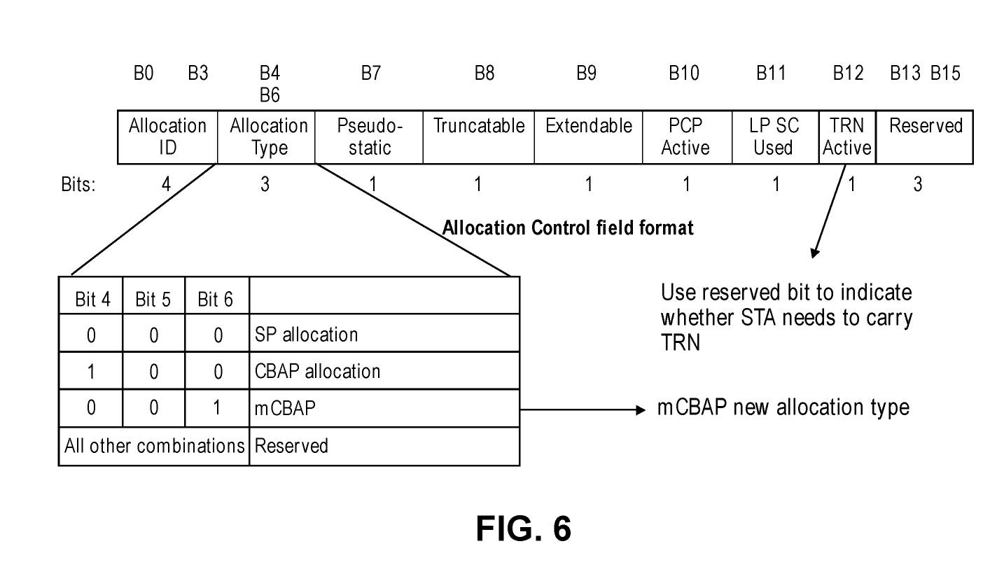

FIG. 6 shows a format for a subfield in the Allocation Field of FIG. 5, according to an embodiment of the invention. In the Allocation Control subfield of FIG. 5, which is shown in expanded form in FIG. 6, one of the previously reserved bits B12-B15 may be used to show that the relevant STA is using a training sequence in its RTS or CTS frame when the Allocation type is CBAP. Bit B12 is shown for this purpose, but any of bits B13-B15 may be used in an alternative embodiment. In other embodiments, a particular multi-bit combination of bits B12-B15 might be used for this purpose. In addition, bits B4-B6 may use a new previously unused value to indicate the mCBAP discussed earlier in this document is being used. Value 001 is shown, but it could be any value other than 000 or 100, which have been previously defined for other purposes.

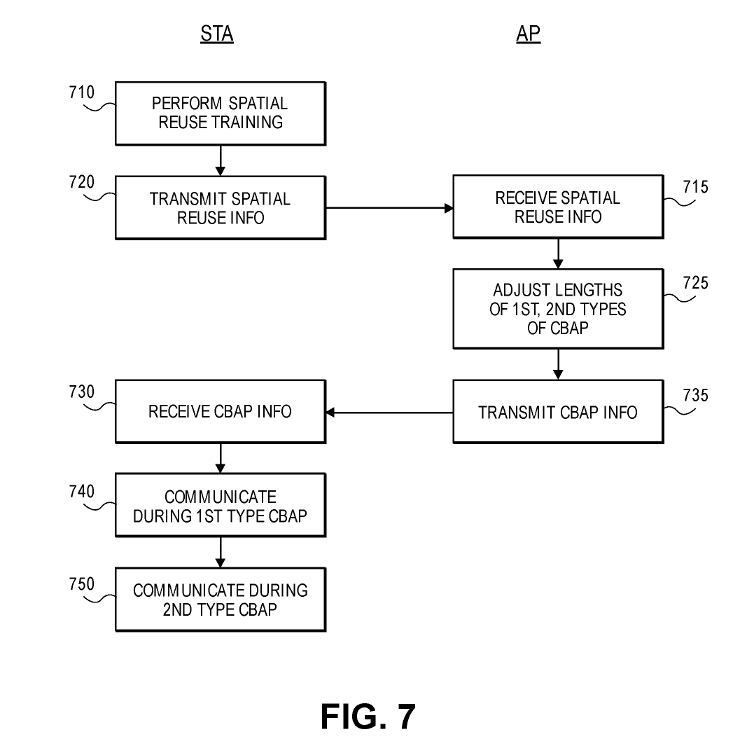

FIG. 7 shows a flow diagram of a method, according to an embodiment of the invention. FIG. 7 shows both operations performed by a STA and operations performed by the AP acting as its network controller. In a typical network, multiple such STAs may be interacting with the AP as shown and performing the indicated operations.

At 710 the STA may perform spatial reuse training. As previously described, this may include establishing a directional link with another STA, and then determining if communicating over this directional link causes interference with, or by, another pair of STAs communicating with each other directionally. The results of this training may then be transmitted to the AP at 720 and received by the AP at 715.

As previously described, the AP may be planning to announce two different types of CBAP time blocks during the beacon interval, with one of those types being designated for STAs that include spatial reuse training during their communication. In some embodiments the AP may consider the spatial reuse training results from multiple spatial reuse STA pairs, and at 725 determine the relative durations of those two types of CBAP based on the implied demand for them. The timing for these two types of CBAP may then be transmitted by the AP at 735 and received by the STA at 730.

Once the STA has learned (from operation 730) when each type of CBAP is scheduled during the beacon interval, it may access the medium with communications involving spatial reuse training during the 1^{st} type of CBAP at 740, and access the medium with other communications during the 2^{nd} type of CBAP at 750.

### EXAMPLES

The following examples pertain to particular embodiments.

Example 1 includes a first wireless communications device having a processor, a memory, and a medium access control (MAC) module, the processor, memory, and MAC module configured to receive a beacon from a PBSS Control Point/access point (PCP/AP) indicating timing for a first type of contention based access period (CBAP) and a second type of CBAP; communicate with a second wireless communications device over a directional communications link; wherein the communication with the second wireless communications device is to take place during the first type of CBAP if the communication with the second communication device includes spatial reuse training; wherein the communication with the second wireless communications device is to take place during the second type of CBAP if the communication with the second communications device does not include spatial reuse training.

Example 2 includes the first device of example 1, wherein the first type of CBAP and second type of CBAP are to occur during a same beacon interval.

Example 3 includes the first device of example 1, wherein the spatial reuse training is to include a request-to-send (RTS) with at least a first training sequence appended and a clear-to-send (CTS) with at least a second training sequence appended during the first type of CBAP.

Example 4 includes the first device of example 3, wherein the first device is configured to transmit the RTS and receive the CTS.

Example 5 includes the first device of example 3, wherein the first device is configured to receive the RTS and transmit the CTS.

Example 6 includes the first device of example 1, including at least one antenna array.

Example 7 includes a method of wireless communication, comprising receiving a beacon from a PBSS Control Point/access point (PCP/AP) indicating timing for a first type of contention based access period (CBAP) and a second type of CBAP; communicating with a second wireless communications device over a directional communications link; wherein said communicating with the second wireless communications device takes place during the first type of CBAP if the communication with the second communication device includes spatial reuse training; wherein said communicating with the second wireless communications device takes place during the second type of CBAP if the communication with the second communications device does not include spatial reuse training.

Example 8 includes the method of example 7, wherein the first type of CBAP and second type of CBAP occur during a same beacon interval.

Example 9 includes the method of example 7, wherein the spatial reuse training includes a request-to-send (RTS) with at least a first training sequence appended and a clear-to-send (CTS) with at least a second training sequence appended during the first type of CBAP.

Example 10 includes the method of example 9, wherein said communicating includes transmitting the RTS and receiving the CTS.

Example 11 includes the method of example 9, wherein said communicating includes receiving the RTS and transmitting the CTS.

Example 12 includes a computer-readable non-transitory storage medium that contains instructions, which when executed by one or more processors results in performing operations comprising receiving a beacon from a PBSS Control Point/access point (PCP/AP) indicating timing for a first type of contention based access period (CBAP) and a second type of CBAP; communicating with a second wireless communications device over a directional communications link; wherein said communicating with the second wireless communications device takes place during the first type of CBAP if the communication with the second communication device includes spatial reuse training; wherein said communicating with the second wireless communications device takes place during the second type of CBAP if the communication with the second communications device does not include spatial reuse training.

Example 13 includes the medium of example 12, wherein the operations further comprise appending a first training sequence to a request-to-send (RTS) for transmission during the first type of CBAP.

Example 14 includes the medium of example 12, wherein the operations further comprise appending a second training sequence to a clear-to-send (CTS) for transmission during the first type of CBAP.

Example 15 includes the medium of example 12, wherein said communicating with the second wireless communications device during the first type of CBAP comprises transmitting a request-to-send and receiving a clear-to-send.

Example 16 includes the medium of example 12, wherein said communicating with the second wireless communications device during the first type of CBAP comprises receiving a request-to-send and transmitting a clear-to-send.

Example 17 includes a first wireless communications device, the device having means for communicating with a second wireless communications device over a directional communications link during a contention based access period (CBAP); wherein the CBAP has been designated by a PBSS Control Point/access point (PCP/AP) as a first type of CBAP if the communications with the second wireless communications device includes spatial reuse training, and the CBAP has been designated as s second type of CBAP if the communications with the second wireless communications device does not include spatial reuse training.

Example 18 includes the first wireless communications device of example 17, wherein the first wireless communications device further has means for appending a first training sequence to a request-to-send (RTS) for transmission during the first type of CBAP.

Example 19 includes the first wireless communications device of example 17, wherein the first wireless communications device further has means for appending a second training sequence to a clear-to-send (CTS) for transmission during the first type of CBAP.

Example 20 includes the first wireless communications device of example 17, wherein the first wireless communications device further has means for transmitting a request-to-send and receiving a clear-to-send during said communicating with the second wireless communications device during the first type of CBAP.

Example 21 includes the first wireless communications device of example 17, wherein the first wireless communications device further has means for receiving a request-to-send and transmitting a clear-to-send during said communicating with the second wireless communications device during the first type of CBAP.

Example 22 includes a first wireless communications device having a processor, a memory, and a medium access control (MAC) module, the processor, memory, and MAC module configured to operate as a PBSS Control Point/access point (PCP/AP) in a wireless network that includes multiple STAs; receive reports of spatial reuse from multiple ones of the multiple STAs; and transmit a beacon indicating first and second time periods during a beacon interval, the first time period indicated for a first type of contention based access period (CBAP), and the second time period indicated for a second type of CBAP; wherein relative durations of the first and second type of CBAPs are based on the reports of spatial reuse.

Example 23 includes the first device of example 22, wherein the reports of spatial reuse include reports of spatial reuse with training sequences and spatial reuse without training sequences.

Example 24 includes the first device of example 22, wherein the processor, memory, and MAC module are further configured to transmit an indicator of minimum packet size to be used by the STAs when the STAs determine whether to use the first or second type of CBAP.

Example 25 includes the first device of example 22, wherein the first device includes at least one antenna array.

Example 26 includes a computer-readable non-transitory storage medium that contains instructions, which when executed by one or more processors results in performing operations comprising operating as a PBSS Control Point/access point (PCP/AP) in a wireless network that includes multiple STAs; receiving reports of spatial reuse from multiple ones of the multiple STAs; and transmitting a beacon indicating first and second time periods during a beacon interval, the first time period indicating a first type of contention based access period (CBAP) with a first duration, and the second time period indicating a second type of CBAP with a second duration; wherein relative lengths of the first and second durations are based on the reports of spatial reuse.

Example 27 includes the medium of example 26, wherein the reports of spatial reuse include reports of spatial reuse with training sequences and spatial reuse without training sequences.

Example 28 includes the medium of example 26, wherein the reports of spatial reuse include reports of devices performing spatial reuse and devices not performing spatial reuse.

Example 29 includes the medium of example 26, wherein the operations further comprise transmitting an indicator of minimum packet size to be used by the STAs for the STAs to determine whether to use the first or second type of CBAP.

Example 30 includes a wireless communications device having means to perform operations comprising operating as a PBSS Control Point/access point (PCP/AP) in a wireless network that includes multiple STAs; receiving reports of spatial reuse from multiple ones of the multiple STAs; transmitting a beacon indicating first and second time periods during a beacon interval, the first time period indicating a first type of contention based access period (CBAP), and the second time period indicating a second type of CBAP; wherein relative durations of the first and second type of CBAPs are based on the reports of spatial reuse.

Example 31 includes the wireless communications device of example 30, wherein the reports of spatial reuse include reports of spatial reuse with training sequences and spatial reuse without training sequences.

Example 32 includes the wireless communications device of example 30, wherein the reports of spatial reuse include reports of devices performing spatial reuse and devices not performing spatial reuse.

Example 33 includes the wireless communications device of example 30, further comprising means for transmitting an indicator of minimum packet size to be used by the STAs for the STAs to determine whether to use the first or second type of CBAP.

Example 34 includes a method of wireless communications, comprising operating as a PBSS Control Point/access point (PCP/AP) in a wireless network that includes multiple STAs; receiving reports of spatial reuse from multiple ones of the multiple STAs; and transmitting a beacon indicating first and second time periods during a beacon interval, the first time period indicating a first type of contention based access period (CBAP) with a first duration, and the second time period indicating a second type of CBAP with a second duration; wherein relative lengths of the first and second durations are based on the reports of spatial reuse.

Example 35 includes the method of example 34, wherein the reports of spatial reuse include reports of spatial reuse with training sequences and spatial reuse without training sequences.

Example 36 includes the method of example 34, wherein the reports of spatial reuse include reports of devices performing spatial reuse and devices not performing spatial reuse.

Example 37 includes the method of example 34, wherein further comprising transmitting an indicator of minimum packet size to be used by the STAs for the STAs to determine whether to use the first or second type of CBAP.

Example 38 includes a wireless communications device having a processor, a memory, and a medium access control (MAC) module, the processor, memory, and MAC module configured to communicate a beacon, the beacon including an allocation field having an allocation control subfield, a source address identification (AID) subfield and a destination AID subfield; wherein the allocation control subfield is to include at least one bit indicating if a destination STA needs to perform spatial training.

Example 39 includes the device of example 38, wherein the allocation control subfield is to include an allocation type subfield for indicating a type of CBAP access allocation allocated for spatial reuse purposes.

Example 40 includes the device of example 38, wherein the source AID subfield is to contain a source AID for a PBSS Control Point/access point (PCP/AP) and the destination AID subfield is to contain a destination AID for the PCP/AP.

Example 41 includes the device of example 38, wherein the source and destination AID subfields are each to be one octet in length, and the allocation control subfield is to be two octets in length.

Example 42 includes the device of example 38, the device including at least one antenna array.

Example 43 includes the device of example 38, wherein said communicating the beacon is to include transmitting the beacon.

Example 44 includes the device of example 38, wherein said communicating the beacon is to include receiving the beacon.

Example 45 includes a computer-readable non-transitory storage medium that contains instructions, which when executed by one or more processors results in performing operations comprising communicating a beacon, the beacon including an allocation field having an allocation control subfield, a source address identification (AID) subfield and a destination AID subfield; wherein the allocation control subfield includes at least one bit indicating if a destination STA is to use spatial training.

Example 46 includes the medium of example 45, wherein the allocation control subfield includes an allocation type subfield for indicating a type of CBAP access allocation allocated for spatial reuse purposes.

Example 47 includes the medium of example 45, wherein the source AID subfield contains a source AID for a PBSS Control Point access point (PCP/AP) and the destination AID subfield contains a destination AID for the PCP/AP.

Example 48 includes the medium of example 45, wherein the source and destination AID subfields are each one octet in length, and the allocation control subfield is two octets in length.

Example 49 includes the medium of example 45, wherein the operation of communicating the beacon includes transmitting the beacon.

Example 50 includes the medium of example 45, wherein the operation of communicating the beacon includes receiving the beacon.

Example 51 includes a wireless communications device having means to perform operations comprising communicating a beacon, the beacon including an allocation field having an allocation control subfield, a source address identification (AID) subfield and a destination AID subfield; wherein the allocation control subfield includes at least one bit indicating if a destination STA needs to use spatial training.

Example 52 includes the wireless communications device of example 51, wherein the allocation control subfield includes an allocation type subfield for indicating a type of CBAP access allocation allocated for spatial reuse purposes.

Example 53 includes the wireless communications device of example 51, wherein the source AID subfield contains a source AID for a PBSS Control Point/access point (PCP/AP) and the destination AID subfield contains a destination AID for the PCP/AP.

Example 54 includes the wireless communications device of example 51, wherein the source and destination AID subfields are each one octet in length, and the allocation control subfield is two octets in length.

Example 55 includes the wireless communications device of example 51, wherein the operation of communicating the beacon includes transmitting the beacon.

Example 56 includes the wireless communications device of example 51, wherein the operation of communicating the beacon includes receiving the beacon.

Example 57 includes a method of wireless communications, comprising communicating a beacon, the beacon including an allocation field having an allocation control subfield, a source address identification (AID) subfield and a destination AID subfield; wherein the allocation control subfield includes at least one bit indicating if a destination STA needs to use spatial training.

Example 58 includes the method of example 57, wherein the allocation control subfield includes an allocation type subfield for indicating a type of CBAP access allocation allocated for spatial reuse purposes.

Example 59 includes the method of example 57, wherein the source AID subfield contains a source AID for a PBSS Control Point/access point (PCP/AP) and the destination AID subfield contains a destination AID for the PCP/AP.

Example 60 includes the method of example 57, wherein the source and destination AID subfields are each one octet in length, and the allocation control subfield is two octets in length.

Example 61 includes the method of example 57, wherein the operation of communicating the beacon includes transmitting the beacon.

Example 62 includes the method of example 57, wherein the operation of communicating the beacon includes receiving the beacon.

The foregoing description is intended to be illustrative and not limiting. Variations will occur to those of skill in the art. Those variations are intended to be included in the various embodiments of the invention, which are limited only by the scope of the following claims.

What is claimed is:

1. A first wireless communications device having a processor, a memory, and a medium access control (MAC) module, the processor, memory, and MAC module configured to:
receive a beacon from a PBSS Control Point/access point (PCP/AP) indicating timing for a first type of contention based access period (CBAP) and a second type of CBAP;
communicate with a second wireless communications device over a directional communications link;
wherein the communication with the second wireless communications device is to take place during the first type of CBAP if the communication with the second communication device includes spatial reuse training;
wherein the communication with the second wireless communications device is to take place during the second type of CBAP if the communication with the second communications device does not include spatial reuse training.

2. The first device of claim 1, wherein the first type of CBAP and second type of CBAP are to occur during a same beacon interval.

3. The first device of claim 1, wherein the spatial reuse training is to include a request-to-send (RTS) with at least a first training sequence appended and a clear-to-send (CTS) with at least a second training sequence appended during the first type of CBAP.

4. The first device of claim 3, wherein the first device is configured to transmit the RTS and receive the CTS.

5. The first device of claim 3, wherein the first device is configured to receive the RTS and transmit the CTS.

6. The first device of claim 1, including at least one antenna array.

7. A computer-readable non-transitory storage medium that contains instructions, which when executed by one or more processors results in performing operations comprising:
receive a beacon from a PBSS Control Point/access point (PCP/AP) indicating timing for a first type of contention based access period (CBAP) and a second type of CBAP;
communicate with a second wireless communications device over a directional communications link;
wherein the communication with the second wireless communications device is to take place during the first type of CBAP if the communication with the second communication device includes spatial reuse training;
wherein the communication with the second wireless communications device is to take place during the second type of CBAP if the communication with the second communications device does not include spatial reuse training.

8. The medium of claim 7, wherein the operations further comprise:
appending a first training sequence to a request-to-send (RTS) for transmission during the first type of CBAP.

9. The medium of claim 7, wherein the operations further comprise:
appending a second training sequence to a clear-to-send (CTS) for transmission during the first type of CBAP.

10. A computer-readable non-transitory storage medium that contains instructions, which when executed by one or more processors results in performing operations comprising:
operating as a PBSS Control Point/access point (PCP/AP) in a wireless network that includes multiple STAs;
receiving reports of spatial reuse from multiple ones of the multiple STAs;
transmitting a beacon indicating first and second time periods during a beacon interval, the first time period indicating a first type of contention based access period (CBAP), and the second time period indicating a second type of CBAP;
wherein relative durations of the first and second type of CBAPs are based on the reports of spatial reuse.

11. The medium of claim 10, wherein the reports of spatial reuse include reports of spatial reuse with training sequences and spatial reuse without training sequences.

12. The medium of claim 10, wherein the operations further comprise transmitting an indicator of minimum packet size to be used by the STAs for the STAs to determine whether to use the first or second type of CBAP.

13. A wireless communications device having a processor, a memory, and a medium access control (MAC) module, the processor, memory, and MAC module configured to:
operate as a PBSS Control Point/access point (PCP/AP) in a wireless network that includes multiple STAs;
receive reports of spatial reuse from multiple ones of the multiple STAs; and
transmit a beacon indicating first and second time periods during a beacon interval, the first time period indicating a first type of contention based access period (CBAP), and the second time period indicating a second type of CBAP;
wherein relative durations of the first and second type of CBAPs are based on the reports of spatial reuse.

14. The first wireless communications device of claim 13, wherein the first type of CBAP is to be indicated for STAs providing reports of spatial reuse with training sequences and the second type of CBAP is to be indicated for STAs providing reports of spatial reuse without training sequences

15. The first wireless communications device of claim 13, further comprising an antenna array.

16. A wireless communications device having a processor, a memory, and a medium access control (MAC) module, the processor, memory, and MAC module configured to:
communicate a beacon, the beacon including an allocation field having an allocation control subfield, a source AID subfield and a destination AID subfield;
wherein the allocation control subfield is to include at least one bit indicating if a destination STA needs to carry spatial training.

17. The device of claim 16, wherein the allocation control subfield is to include an allocation type subfield for indicating a type of CBAP access allocation allocated for spatial reuse purposes.

18. The device of claim 16, wherein the source AID subfield is to contain a source AID for a PBSS Control Point/access point (PCP/AP) and the destination AID subfield is to contain a destination AID for the PCP/AP.

19. The device of claim 16, wherein the source and destination AID subfields are each one octet in length, and the allocation control subfield is two octets in length.

20. The device of claim 16, the device including at least one antenna array.

21. A computer-readable non-transitory storage medium that contains instructions, which when executed by one or more processors results in performing operations comprising:
communicating a beacon, the beacon including an allocation field having an allocation control subfield, a source AID subfield and a destination AID subfield;
wherein the allocation control subfield includes at least one bit indicating if a destination STA is to use spatial training.

22. The medium of claim 21, wherein the allocation control subfield includes an allocation type subfield for indicating a type of CBAP access allocation allocated for spatial reuse purposes.

23. The medium of claim 21, wherein the source AID subfield contains a source AID for a PBSS Control Point/access point (PCP/AP) and the destination AID subfield contains a destination AID for the PCP/AP.

24. The medium of claim 21, wherein the source and destination AID subfields are each one octet in length, and the allocation control subfield is two octets in length.
